(19) United States
(12) Patent Application Publication
(10) Pub. No.: US 2026/0163987 A1
(43) Pub. Date: Jun. 11, 2026

(54) IMAGE FORMING APPARATUS, METHOD THEREFOR, AND STORAGE MEDIUM

(71) Applicant: CANON KABUSHIKI KAISHA, Tokyo (JP)

(72) Inventor: YURINO KOJIMA, Chiba (JP)

(21) Appl. No.: 19/367,684

(22) Filed: Oct. 23, 2025

(30) Foreign Application Priority Data
Oct. 31, 2024 (JP) 2024-191752

(51) Int. Cl. H04N 1/00

(52) U.S. Cl. CPC H04N 1/00421; H04N 1/00037; H04N 2201/0094

(57) ABSTRACT

An image forming apparatus includes a display unit, a storage unit configured to store execution date and time of a print job and setting information of the executed print job in association with each other, at least one memory storing a program, at least one processor executing the program to set a period having a predetermined unit, acquire, from the storage unit, the setting information of print jobs executed within the set period, and calculate information about environmental load based on the setting information, where the display unit displays the information about the environmental load and a warning about the displayed information about the environmental load in a case where the period is set and a condition is satisfied for the period.

### BACKGROUND

### Field of the Technology

The present disclosure relates to an image forming apparatus, a method for the image forming apparatus, and a storage medium.

### Description of the Related Art

In multifunction peripherals, there is a trend toward reducing the environmental load of printing. For example, the number of sheets used for printing is reduced by using a double-sided printing setting or an N-in-one printing setting and/or the amount of toner used is reduced by using a monochrome printing setting.

A technique that calculates the number of printed sheets, the paper reduction rate, etc., based on job log information stored in a device and that displays the calculation results on a screen is a method for visually checking how much reduction in environmental load has been achieved. Japanese Patent Laid-Open No. 2013-012198 describes a method in which a job log information aggregation period is selectable. In this method, the past environmental load information and the current environmental load information are compared with each other, and a user can check how much the user has contributed to reducing the environmental load through the comparison with the past information.

There is a limit in Japanese Patent Laid-Open No. 2013-012198 to the number of job log entries that can be stored for reference. Consequently, the past environmental load information may not be displayed in a complete state, depending on the display timing. In this case, the user cannot check the storage status of the information inside the device. Thus, in this case, there is a risk that the user may form an incorrect perception due to the incomplete environmental load information.

### SUMMARY

The present disclosure is directed to providing an image forming apparatus that prevents a user from forming an incorrect perception in a case where incomplete environmental load information is displayed for a specified display period. According to an aspect of the present disclosure, an image forming apparatus includes a display unit, a storage unit configured to store execution date and time of a print job and setting information of the executed print job in association with each other, at least one memory storing a program, at least one processor executing the program to set a period having a predetermined unit, acquire, from the storage unit, the setting information of print jobs executed within the set period, and calculate information about environmental load based on the setting information, and a display unit configured to display the information about the environmental load, wherein the display unit displays a warning about the displayed information about the environmental load in a case where the period is set and a condition is satisfied for the period.

Features of the present disclosure will become apparent from the following description of embodiments with reference to the attached drawings. The following description of embodiments is described by way of example.

### BRIEF DESCRIPTION OF THE DRAWINGS

FIG. 1 is a front view of an image forming apparatus.

FIG. 2 is a functional block diagram of an image forming system.

FIG. 3 illustrates an example of a job log information table.

FIG. 4 is a display example of an environmental load information display screen.

FIG. 5A is a display example of the environmental load information display screen when a display period is selected, and FIG. 5B is a display example when “TODAY” has been selected.

FIG. 6 is a flowchart illustrating an environmental load information display screen display process according to a first embodiment.

FIG. 7 is a flowchart illustrating a job log information deficiency checking process.

FIG. 8 is a display example of a partially missing job log information notification screen.

FIG. 9 is a display example of the environmental load information display screen after the partially missing job log information notification screen is displayed.

FIG. 10 is a display example of the environmental load information display screen displaying initial values.

FIG. 11 is a flowchart illustrating an environmental load information display screen display process according to a second embodiment.

FIG. 12 is a flowchart illustrating a display period correction process.

FIG. 13 is a display example of an environmental load information display screen according to the second embodiment.

FIG. 14A is a display example of an environmental load information setting item screen, and FIG. 14B is a display example of a display period setting screen for comparing this month and last month.

FIG. 15 is a flowchart illustrating an environmental load information display screen display process according to a third embodiment.

FIG. 16 is a flowchart illustrating a comparison display period calculation process.

FIG. 17A is a display example of the environmental load information display screen in which “THIS MONTH (for comparison)” has been selected, and FIG. 17B is a display example of the environmental load information display screen in which “LAST MONTH (for comparison)” has been selected.

FIG. 18 is a display example of a cloud database information usage setting screen.

FIG. 19 is a flowchart illustrating an environmental load information display screen display process according to a fourth embodiment.

FIG. 20 illustrates a display example of the environmental load information display screen when past job log information stored in a cloud database is also referred to.

FIG. 21 illustrates an example of the past job log information stored in the cloud database.

FIG. 22A illustrates an example of an environmental load information table in which information within a period is complete, and FIG. 22B illustrates an example of an environmental load information table in which information within the period is incomplete.

FIG. 23 is a display example of a home screen displayed on the image forming apparatus.

### DESCRIPTION OF THE EMBODIMENTS

Each embodiment of the present disclosure will be described in detail with reference to the accompanying drawings. It should be noted that the following embodiments are not intended to limit the disclosure according to the claims, and not all combinations of features described in the embodiments are necessarily essential to the solutions of the present disclosure. In the embodiments, an image forming apparatus is used as an example of an information processing apparatus, but the disclosure is not limited thereto.

Hereinafter, an image forming apparatus according to the present disclosure will be described with reference to the drawings. Examples of the image forming apparatus include a printer, a copying machine, a facsimile machine, and a multifunction peripheral having functions of these machines. The image forming apparatus has a function (a printing function) of forming an image on a sheet as a recording medium.

### First Embodiment

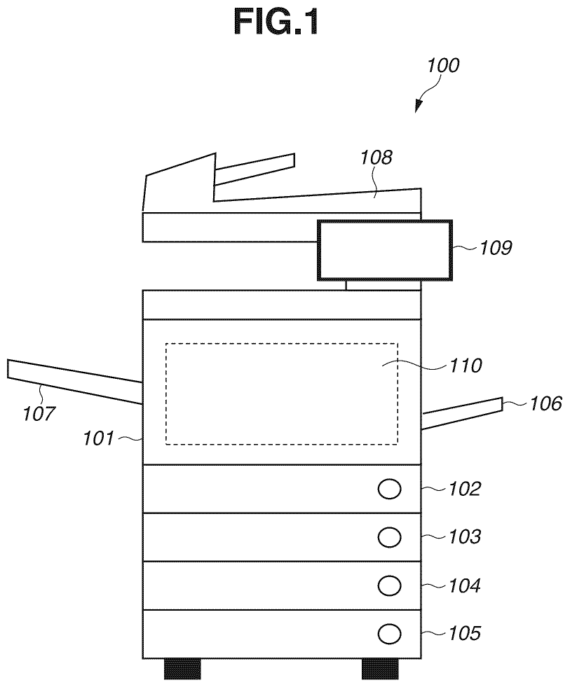

An image forming apparatus 100 illustrated in FIG. 1 is a multifunction peripheral that forms an image on a sheet. Examples of the sheet include paper such as a sheet and an envelope, a plastic film such as an overhead projector (OHP) sheet, and cloth. In addition, when a term “sheet” or “paper feed” is used in the drawings, etc., unless otherwise specified, the term refers to not only a sheet in general, but also a sheet other than paper.

The image forming apparatus 100 includes devices such as a printer unit 101, a scanner unit 108, a plurality of paper feed cassettes 102, 103, 104, and 105, a manual feed tray 106, a discharge tray 107, and a user interface (UI) screen 109. Hereinafter, the paper feed cassettes 102, 103, 104, and 105 and the manual feed tray 106 will be referred to as paper feed stages, unless each component is specifically distinguished from each other. The paper feed cassettes 102 to 105 will be referred to as paper feed cassettes 1 to 4 when the paper feed cassettes 102 to 105 are distinguished from each other.

The scanner unit 108, as an image reading device, optically scans a document and converts the scanned document into electronic image data by a photoelectric conversion element such as a charge-coupled device (CCD) sensor. The printer unit 101 includes a printer engine 110, which is an example of an image forming unit, and the printer engine 110 forms an image on a sheet based on the image data received from the scanner unit 108 or an external host computer. Each of the paper feed cassettes 102 to 105 stores sheets. The manual feed tray 106 supports sheets placed thereon. The sheets stored in the paper feed cassettes 102 to 105 and on the manual feed tray 106 are fed to the printer engine 110 while being separated one by one by a paper feed unit (not illustrated). The paper feed cassettes 102 to 105 and the manual feed tray 106 are examples of the paper feed stages that store sheets to be supplied to the image forming unit. An individual sheet, on which an image has been formed by the printer engine 110, is discharged to the discharge tray 107 as a discharge unit.

The UI screen 109 functions as a display unit that displays information to the user and an input unit that receives an instruction from the user. The UI screen 109 includes a screen display unit including a display such as a liquid crystal display (LCD). The UI screen 109 also includes an operation input unit including a touch panel, which is installed on the display and functions as software keys that use positional relationships with operation targets displayed and operated on the display, and hardware keys such as a numeric keypad. When a job is not executed, the UI screen 109 can display a home screen on which various types of functional applications are displayed, and a dashboard screen on which a device status can be checked.

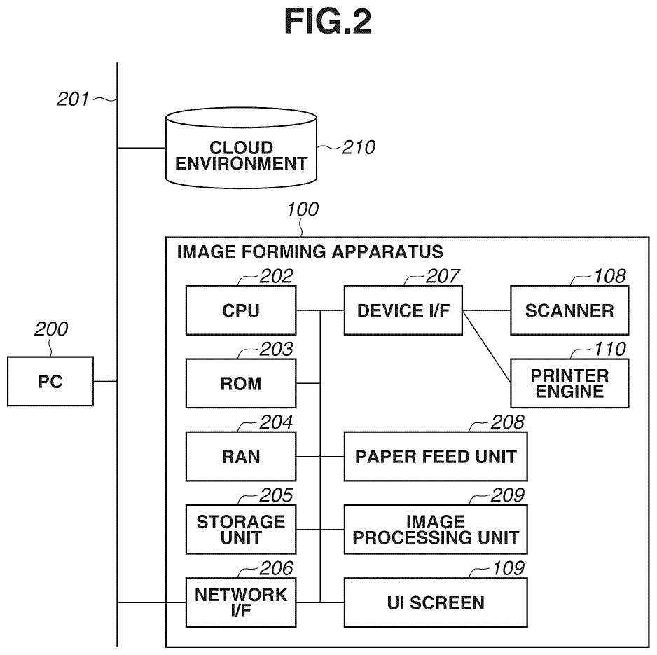

Next, an image forming system including the image forming apparatus 100 will be described with reference to FIG. 2.

The image forming apparatus 100 is connected to a wired or wireless network 201 via a network interface (I/F) 206, and communicates with an information processing apparatus such as a personal computer (PC) 200.

A printer driver is installed in the PC 200 as driver software that generates a job (hereinafter, a print job) that instructs the image forming apparatus 100 to form an image on a sheet. The printer driver generates a print job described by a page description language (PDL) based on document data received from a document creation application in the PC 200. Examples of the PDL include PostScript (PS), Printer Command Language (PCL), and Laser Imaging Printing System (LIPS®). The PC 200 includes a control unit such as a central processing unit (CPU), and a storage unit such as a read-only memory (ROM), a random access memory (RAM) (rewritable memory), and a hard disk drive (HDD). The printer driver transmits the generated print job to the image forming apparatus 100 via the network 201.

The image forming apparatus 100 is controlled by a CPU 202, and the CPU 202 operates based on a program stored in a RAM 204. A ROM 203 is a boot ROM, and stores a system boot program. A storage unit 205 stores, for example, system software, image data, and a program for controlling the operation of the image forming apparatus 100. The program stored in the storage unit 205 is loaded into the RAM 204, and the CPU 202 controls the operation of the image forming apparatus 100 based on the program. In the following description, unless otherwise specified, the CPU 202 executes the steps of the control processes of the image forming apparatus 100.

A paper feed unit 208 is a collection of paper feed stages such as the paper feed cassettes 102 to 105 and the manual feed tray 106, and is controlled by the CPU 202.

An image processing unit 209 performs image processing on a print job received via the network I/F 206, and processes image data transmitted via a device I/F 207. The image processing unit 209 converts the image data transmitted from the PC 200 into raster image data, and stores the raster image data in the storage unit 205. The stored image data is transmitted to the printer engine 110 as a video signal via the device I/F 207, and is used in an image forming operation executed by the printer engine 110.

A cloud database 210 is a cloud environment that is present on the network 201, and can store, for example, information that cannot be stored within the capacity of the storage unit 205 and information that is externally released to the network 201. The cloud database 210, for example, stores information about past job logs, the consumption status of consumables such as toner and parts, etc., and can be referred to from the image forming apparatus 100 via the network 201.

### (Job Log Information)

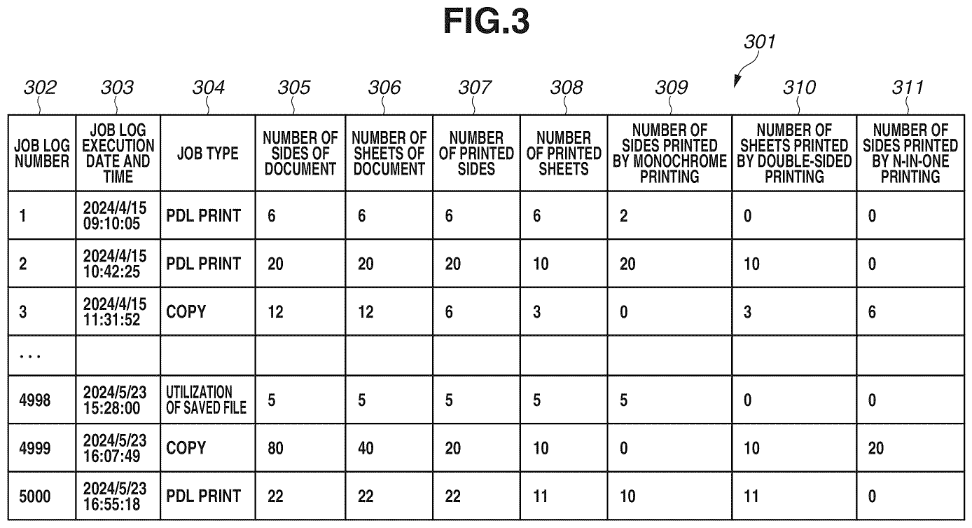

The image forming apparatus 100 stores the executed print jobs and scan jobs in the storage unit 205 as job log information in association with their respective execution dates and times and setting information. FIG. 3 illustrates an example of job log information table 301 (hereinafter, referred to as “job log information”). In the present embodiment, NUMBER OF SIDES OF DOCUMENT 305 to NUMBER OF SIDES PRINTED BY N-IN-ONE PRINTING 311 represent the setting information.

In the job log information 301, an individual job log entry includes information about a JOB LOG NUMBER 302 to the NUMBER OF SIDES PRINTED BY N-IN-ONE PRINTING 311. Hereinafter, one job log entry will be described as an example. The JOB LOG NUMBER 302 represents a number assigned to each job log entry. An older job is assigned a smaller number. There is an upper limit to the number of job log entries that can be stored. In the present embodiment, up to 5,000 job log entries can be stored. For example, when a new job log entry is stored, if 5,000 job log entries have already been stored, the job log entry having the oldest job execution date among the stored job log entries is deleted, and the new job log entry is stored.

A JOB EXECUTION DATE AND TIME 303 represents information indicating the date and time of the execution of the job. This information is recorded in Uniplexed Information and Computing Service (UNIX®) time, in YYYY/MM/DD format, or the like. A JOB TYPE 304 represents information indicating the type of job executed. A job type such as “PDL PRINT”, “COPY”, or “SCAN AND SAVE” is stored.

The NUMBER OF SIDES OF DOCUMENT 305 represents the number of sides of the document of the job. The NUMBER OF SHEETS OF DOCUMENT 306 represents the number of sheets of the document of the job. In the present embodiment, the “document” refers to document data received from external to the image forming apparatus 100 (for “PDL print”), document data read by the scanner unit 108 (for “copy” or “scan and save”), document data stored in the storage unit 205 (for “print saved file”), etc.

The NUMBER OF PRINTED SIDES 307 represents the number of sides printed by the job The NUMBER OF PRINTED SHEETS 308 represents the number of sheets printed by the job. The NUMBER OF PRINTED SIDES 307 to the NUMBER OF SIDES PRINTED BY N-IN-ONE PRINTING 311 represent values related to printed outputs. Thus, “0” may be stored for a type of job that does not involve printing, such as “SCAN AND TRANSMIT”.

The NUMBER OF SIDES PRINTED BY MONOCHROME PRINTING 309 represents information indicating the number of sides printed by monochrome printing from among the outputs printed by the job. For example, in a case where the front side of an output sheet is printed in color and the back side of the output sheet is printed in monochrome, “1” is counted as the number of sides printed by monochrome printing.

The NUMBER OF SHEETS PRINTED BY DOUBLE-SIDED PRINTING 310 represents information indicating the number of sheets printed by double-sided printing from among the outputs printed by the job. When outputs printed by single-sided printing and outputs printed by double-sided printing are mixed in a single job, only the number of sheets printed by double-sided printing is counted.

The NUMBER OF SIDES PRINTED BY N-IN-ONE PRINTING 311 represents information indicating the number of sides of the outputs printed by aggregating a plurality of document sides onto one side, for example, by 2-in-1 printing. For example, when seven sides of the document are printed by using the 2-in-1 print setting, two sides of the document are laid out on one side at the printing, and thus, the number of sides to be counted is “4”.

As an example, the job log entry having “2” as the job log number in FIG. 3 is information about a PDL print executed on 2024/04/15. The job log entry having “2” as the job log number indicates that the number of sheets of the document is 20, that the monochrome printing is set, that the N-in-one printing is not set, and that 10 sheets have been printed by double-sided printing as outputs.

### (Environmental Load Information)

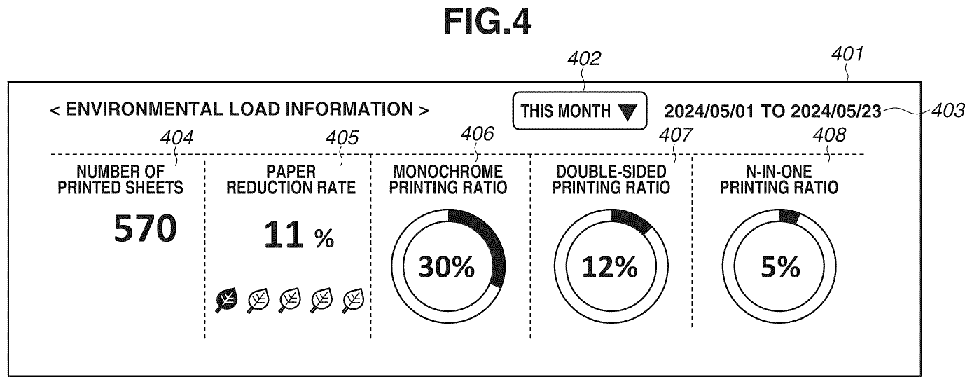

Next, environmental load information will be described. The environmental load information is information indicating the extent to which paper and toner usage has been reduced in print jobs using the image forming apparatus 100. Specifically, the environmental load information is information about the print jobs executed, and includes information about the print settings that reflects the reduction effects on paper and toner usage. FIG. 4 illustrates a display example of the environmental load information according to the present embodiment.

An environmental load information display screen 401 includes a display period selection drop-down menu 402, a display period 403, the number of printed sheets 404, a paper reduction rate 405, a monochrome printing ratio 406, a double-sided printing ratio 407, and an N-in-one printing ratio 408.

By pressing a triangle mark of the display period selection drop-down menu 402, a display period in a predetermined unit can be selected. The selectable periods according to the present embodiment are “TODAY”, “THIS WEEK”, “THIS MONTH”, and “LAST MONTH”. “TODAY” indicates the current date that is set in the image forming apparatus 100. “THIS WEEK” indicates the period from the immediately preceding Sunday to the current date. “THIS MONTH” indicates the period from the first day of this month to the current date. “LAST MONTH” indicates the period from the first day of the last month to the last day of the last month. Alternatively, the display period selection drop-down menu 402 may additionally include “ENTIRE PERIOD” as one of the selectable periods. In a case where the “ENTIRE PERIOD” is selected, all pieces of environmental load information may be displayed.

The display period 403 displays a display period corresponding to the period selected from the display period selection drop-down menu 402 in YYYY/MM/DD format. For example, assuming that the current date is Thursday, May 23, 2024, the display periods for each selection are as follows. When “TODAY” is selected, the display period is from “2024/05/23 to 2024/05/23”. When “THIS WEEK” is selected, the display period is from “2024/05/19 to 2024/05/23”. When “THIS MONTH” is selected, the display period is from “2024/05/01 to 2024/05/23”. When “LAST MONTH” is selected, the display period is from “2024/04/01 to 2024/04/30”.

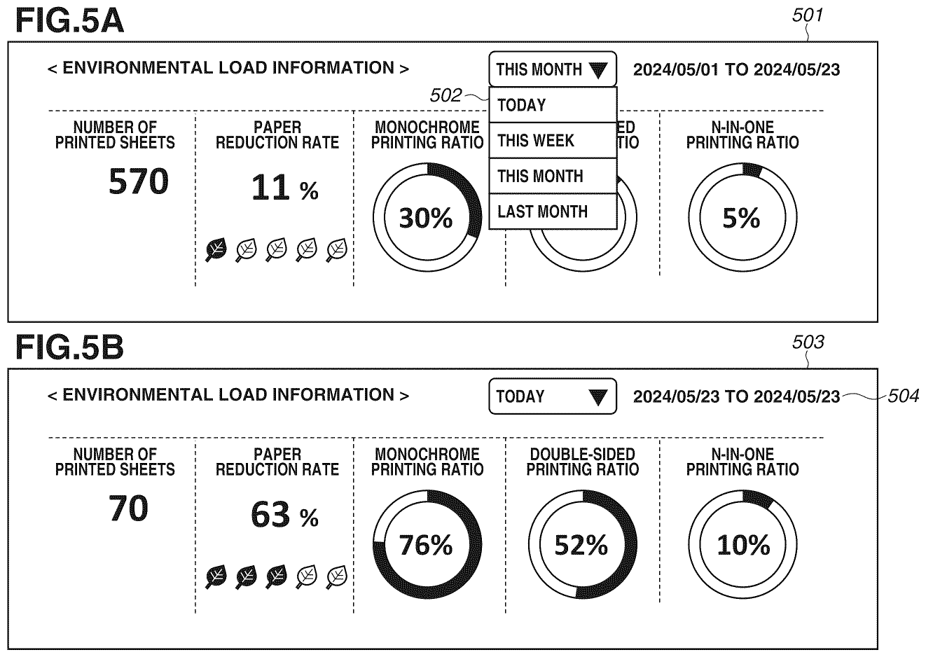

FIGS. 5A and 5B illustrate display period selection screens displayed by pressing the triangle mark of the display period selection drop-down menu 402. When the triangle mark is pressed, display period selection drop-down options 502 are displayed as illustrated in FIG. 5A, enabling the user to select a display period. FIG. 5B illustrates an environmental load information display screen 503 when the user selects “TODAY” in FIG. 5A. “TODAY” is selected from the display period selection drop-down options 502, the start date of a display period 504 is set to the current date, and the numeric values of the respective items of environmental load information for the print jobs executed today are displayed.

The number of printed sheets 404 represents the total number of printed sheets S_{prt_med}, which is the sum of the values of the NUMBER OF PRINTED SHEETS 306 within the display period. The total number of printed sheets S_{prt_med} can be obtained by adding up the values of the NUMBER OF PRINTED SHEETS 308 of the jobs within the display period.

The paper reduction rate 405 represents the extent to which the output of paper has been reduced compared to a case where all of the received document data is printed by using the single-sided printing setting and no N-in-one printing setting. A paper reduction rate Dec can be obtained by using the total number of sides of document S_{org_imp}, which is the sum of the values of the NUMBER OF SIDES OF DOCUMENT 305, and the total number of printed sheets S_{prt_med} within the display period as illustrated in Equation 1.

$$Dec = \{ ( {S}_{org\_imp} - {S}_{prt\_med} ) / {S}_{org\_imp} \} \times 100 \qquad ( Equation 1 )$$

Five leaf icons in total are displayed below the paper reduction rate 405, and they are colored sequentially from left to right based on the paper reduction rate Dec. A greater number of colored leaves indicates a higher paper reduction rate, indicating that the environmental load has been effectively reduced. The relationship between the paper reduction rate Dec and the leaf icons is as follows. When the paper reduction rate is 0%, no leaves are colored. When the paper reduction rate is from 1% to 20%, the leftmost leaf is colored (one leaf is displayed as colored). When the paper reduction rate is from 21% to 40%, the leaves up to the second leaf from the left are colored (two leaves are displayed as colored). When the paper reduction rate is from 41% to 60%, the leaves up to the third leaf from the left are colored (three leaves are displayed as colored). When the paper reduction rate is from 61% to 80%, the leaves up to the fourth leaf from the left are colored (four leaves are displayed as colored). When the paper reduction rate is from 81% to 100%, all the leaves are colored (five leaves are displayed as colored).

The monochrome printing ratio 406 represents a ratio of the outputs printed by using the monochrome printing setting to the outputs of all the print jobs executed within the display period. A higher monochrome printing ratio indicates that more outputs have been printed by using the monochrome printing setting, indicating greater savings in color toner. A monochrome printing ratio Mono can be obtained by using the total number of sides printed by monochrome printing S_{mono_imp}, which is the sum of the values of the NUMBER OF SIDES PRINTED BY MONOCHROME PRINTING 309, and the total number of printed sides S_{prt_imp}, which is the sum of the values of the NUMBER OF PRINTED SIDES 307, within the display period as illustrated in Equation 2.

$$Mono = ( {S}_{mono\_imp} / {S}_{prt\_imp} ) \times 100 \qquad ( Equation 2 )$$

The double-sided printing ratio 407 represents a ratio of the outputs printed by using the double-sided printing setting to the outputs of the print jobs executed within the display period. A higher double-sided printing ratio indicates that more outputs have been printed by using the double-sided printing setting, indicating greater savings in sheets. A double-sided printing ratio Dup can be obtained by using the total number of sheets printed by double-sided printing S_{dup_med}, which is the sum of the values of the NUMBER OF SHEETS PRINTED BY DOUBLE-SIDED PRINTING 310, and the total number of printed sheets S_{prt_med}, within the display period as illustrated in Equation 3.

$$Dup = ( {S}_{dup\_med} / {S}_{prt\_med} ) \times 100 \qquad ( Equation 3 )$$

The N-in-one printing ratio 408 represents a ratio of the outputs printed by using the N-in-one printing setting to the outputs of the print jobs executed within the display period. A higher N-in-one printing ratio indicates that more outputs have been printed by using the N-in-one printing setting, indicating greater savings in sheets. An N-in-one printing ratio Nup can be obtained by using the total number of sides printed by N-in-one printing S_{nup_imp}, which is the sum of the values of the NUMBER OF SIDES PRINTED BY N-IN-ONE PRINTING 311, and the total number of printed sides S_{prt_imp}, within the display period as illustrated in see Equation 4.

$$Nup = ( {S}_{nup\_imp} / {S}_{prt\_imp} ) \times 100 \qquad ( Equation 4 )$$

The environmental load information display screens 401 and 501 may be displayed independently on the UI screen 109 or may be displayed as part of a status display screen together with other information. In such cases, a notification indicating that some information is missing may be provided.

The environmental load information is calculated based on the job log information, and can be calculated by using the sum of appropriate values within the display period. As described above, there is the upper storage limit to the number of job log entries. Thus, when the display period such as “THIS MONTH” or “LAST MONTH” is selected, part of the job log information within the display period may have already been deleted from the storage unit 205 due to the number of job log entries having already exceeded its upper storage limit. When part of the job log information has been deleted, the environmental load information is calculated by using only the job log entries remaining in the storage unit 205. As a result, the environmental load information that differs from what the user has expected may be provided because the user is not aware that part of the job log information has been deleted.

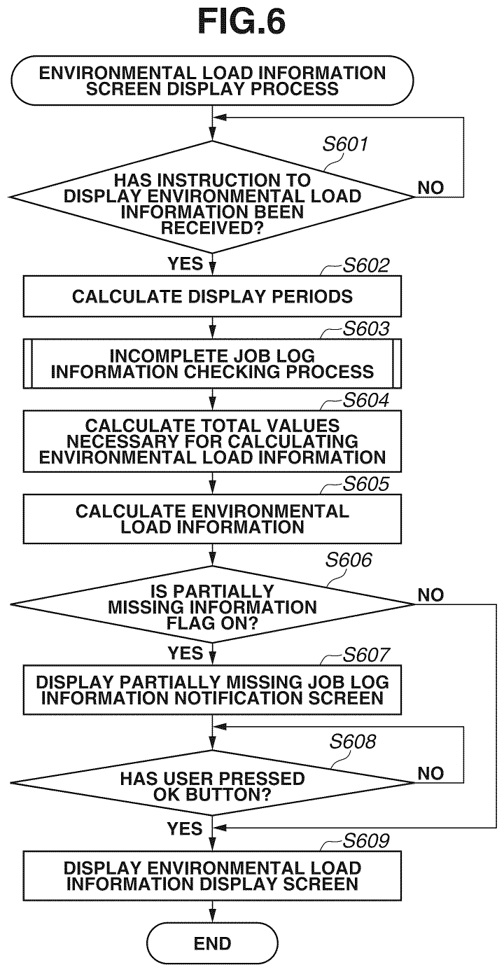

Thus, according to the present embodiment, when part of the job log information within the display period has been deleted, the environmental load information is displayed after the user is notified of this status. FIG. 6 is a flowchart illustrating the operation of the CPU 202 in a case where part of the job log information within the display period has been deleted.

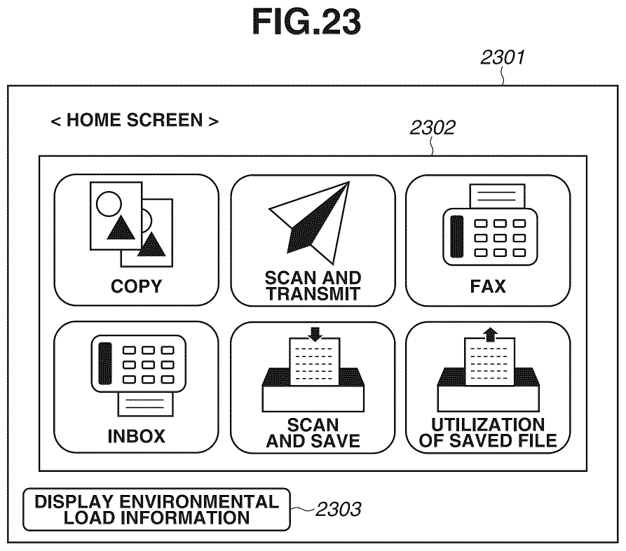

In step S601, the CPU 202 determines whether an instruction to display environmental load information has been received from the user via the UI screen 109. If the instruction has been received (YES in step S601), the process proceeds to step S602. If the instruction has not been received (NO in step S601), the process remains in step S601 and waits for an instruction from the user. FIG. 23 illustrates a home screen 2301 displayed on the UI screen 109. The home screen 2301 includes a function button group 2302. When any of the buttons in the function button group 2302 is pressed, the screen of the corresponding function, such as copying or faxing, is displayed. The home screen 2301 also includes an environmental load information display button 2303. When the user presses the environmental load information display button 2303, the CPU 202 determines that an instruction to display environmental load information has been provided.

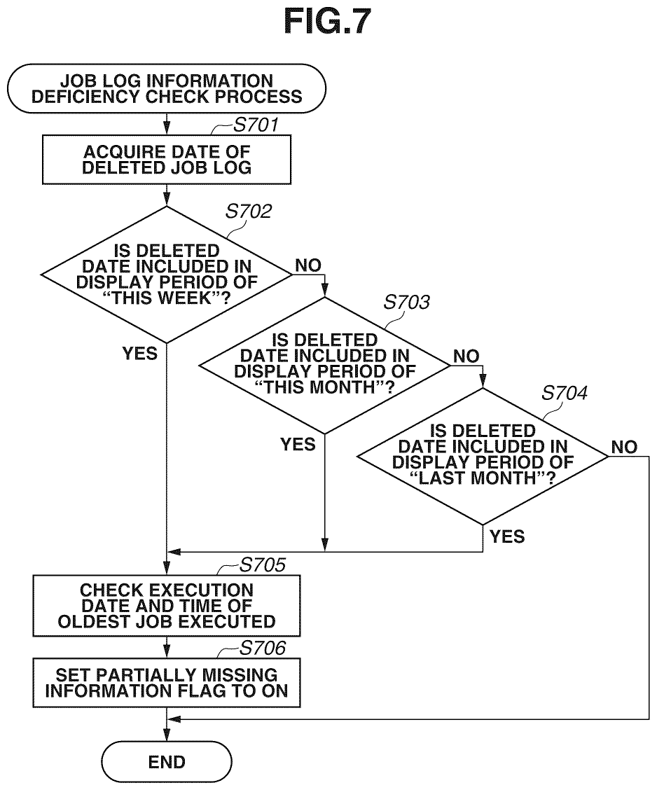

In step S602, based on the current date, the CPU 202 calculates each of the display periods: “TODAY”; “THIS WEEK”; “THIS MONTH”; and “LAST MONTH”, which are the options of the display period 403. Next, in step S603, the CPU 202 checks whether part of the job log information is missing in each display period due to the upper storage limit. If the CPU 202 determines that part of the job log information within any display period has already been deleted, a partially missing information flag is set to ON. Details of the processing in step S603 will be described below with reference to FIG. 7.

In step S604, the CPU 202 calculates, based on the job log information, the total values of the information necessary for the environmental load information. In the present embodiment, jobs in which paper printing occurs (“PDL print”, “copy”, etc.) are targeted. The CPU 202 calculates the sum of the values of the NUMBER OF SIDES OF DOCUMENT 305, the NUMBER OF PRINTED SIDES 307, the NUMBER OF PRINTED SHEETS 308, the NUMBER OF SIDES PRINTED BY MONOCHROME PRINTING 309, the NUMBER OF SHEETS PRINTED BY DOUBLE-SIDED PRINTING 310, and the NUMBER OF SHEETS PRINTED BY N-IN-ONE PRINTING 311 for each job. Next, the process proceeds to step S605.

In step S605, the CPU 202 calculates the environmental load information (the number of printed sheets 404, the paper reduction rate 405, the monochrome printing ratio 406, the double-sided printing ratio 407, and the N-in-one printing ratio 408) based on the total values calculated in step S604. Then, the process proceeds to step S606.

In step S606, the CPU 202 determines whether the partially missing information flag has been set to ON in step S603. If the partially missing information flag has been set to ON (YES in step S606), the process proceeds to step S607. If the partially missing information flag has not been set to ON (NO in step S606), the process proceeds to step S609. In step S609, the CPU 202 displays the environmental load information together with the display period 403 on the UI screen 109, and the process ends.

If step S607, the CPU 202 displays a partially missing job log information notification screen 801 on the UI screen 109 based on the information about the execution date and time of the earliest job from among the stored job log information. The partially missing job log information notification screen 801 will be described in detail below.

In step S608, the CPU 202 determines whether the user has pressed an OK button 803 on the partially missing job log information notification screen 801. If the user has not pressed the OK button 803 (NO in step S608), the process remains in step S608 and waits for the OK button 803 to be pressed by the user. If the user has pressed the OK button 803 (YES in step S608), the CPU 202 determines that the user has viewed the notification screen and acknowledged the state of the device, and the process proceeds to step S609.

FIG. 7 is a flowchart illustrating the job log information deficiency checking process in step S603. First, in step S701, the CPU 202 acquires the date of the job log information deleted from the storage unit 205. As described above, when the number of job log entries exceeds its upper storage limit, the job log information with the oldest job execution date from among the stored job log entries is deleted. In this case, the CPU 202 stores the execution date of the deleted job. Thus, the CPU 202 can confirm up to which point the job log information has been deleted.

Next, in step S702, the CPU 202 determines whether the date of the deleted job log information confirmed in step S701 is included in the display period of “THIS WEEK” calculated in step S602. If the date of the deleted job log information is included in the display period of “THIS WEEK” (YES in step S702), the CPU 202 determines that the job log information in the period included in “THIS WEEK” is partially missing, and the process proceeds to step S705. If the date of the deleted job log information is not included in the display period of “THIS WEEK” (NO in step S702), the CPU 202 determines that there is no missing job log information in the period included in “THIS WEEK”, and the process proceeds to S703.

In step S703, the CPU 202 determines whether the date of the deleted job log information confirmed in step S701 is included in the display period of “THIS MONTH” calculated in step S602.

If the date of the deleted job log information confirmed in step S701 is included in the display period of “THIS MONTH” (YES in step S703), the CPU 202 determines that the job log information in the period included in “THIS MONTH” is partially missing, and the process proceeds to step S705. If the date of the deleted job log information confirmed in step S701 is not included in the display period of “THIS MONTH” (NO in step S703), the CPU 202 determines that there is no missing job log information in the period included in “THIS MONTH”, and the process proceeds to step S704.

In step S704, the CPU 202 determines whether the date of the deleted job log information confirmed in step S701 is included in the display period of “LAST MONTH” calculated in step S602.

If the date of the deleted job log information confirmed in step S701 is included in the display period of “LAST MONTH” (YES in step S704), the CPU 202 determines that the job log information in the period included in “LAST MONTH” is partially missing, and the process proceeds to step S705. If the date of the deleted job log information confirmed in step S701 is not included in the display period of “LAST MONTH” (NO in step S704), the CPU 202 determines that there is no missing job log information in the display period that is used as the calculation target for the environmental load information, and the process ends with the partially missing information flag remaining OFF.

If the date of the deleted job log information confirmed in step S701 is included in any one of the display periods (YES in any of steps S702 to S704) and the process proceeds to step S705, in step S705, the CPU 202 refers to the job log information 301 and checks the execution date and time of the oldest job executed. This information will be used to display the partially missing job log information notification screen 801 in step S607 in FIG. 6. Next, in step S706, the CPU 202 sets the partially missing information flag to ON, and the process ends.

The above-described processing provides for the status in which the job log information is partially missing in any of the display periods being indicated. The processing also serves as a trigger for displaying the partially missing job log information notification screen 801.

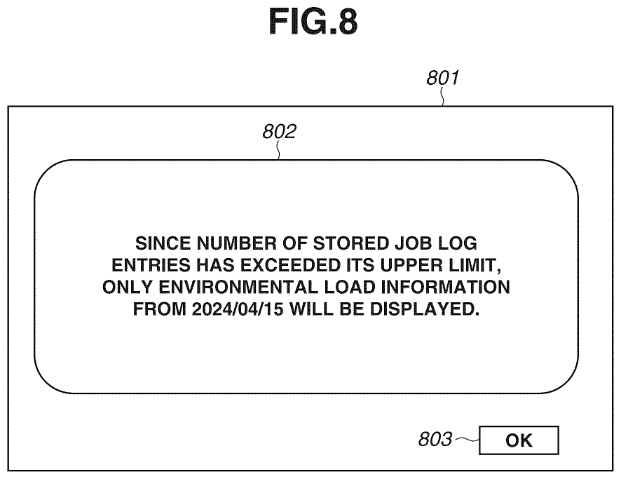

As an example, FIG. 8 illustrates the partially missing job log information notification screen 801 displayed in step S607 assuming that the current date is May 23, 2024, and the execution date of the oldest job stored is Apr. 15, 2024. The partially missing job log information notification screen 801 includes a message 802 and the OK button 803.

The message 802 is a warning message including the reason why the job log information is partially missing and date information indicating the date from which the environmental load information is displayed.

In the present case, the message 802 displays a message such as “Since the number of stored job log entries has exceeded its upper limit, only the environmental load information from 2024/04/15 will be displayed”. If the user presses the OK button 803, the screen transitions to display the environmental load information display screen 401.

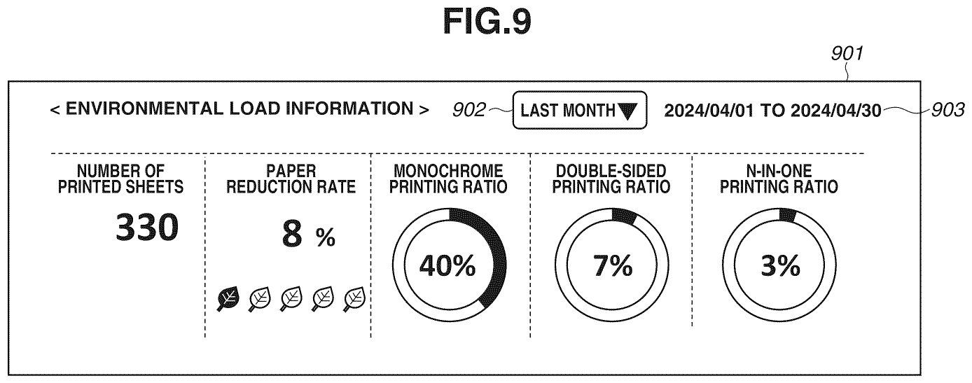

FIG. 9 illustrates the environmental load information display screen 901 displayed in step S609 when “LAST MONTH” has been selected. A display period selection drop-down menu 902 included in the environmental load information display screen 901 indicates “LAST MONTH”, and a display period 903 indicates “2024/04/01 to 2024/04/30”. As the user is notified by the partially missing job log information notification screen 801, the numeric values of the displayed environmental load information are obtained by referring to the job log information from Apr. 15, 2024, to Apr. 30, 2024.

For example, if the date of the deleted job log information is included in the display period of “THIS WEEK” or “THIS MONTH” (YES in step S702 or S703”), this indicates that the job log information is stored up to the middle of this month, and that no job log information is stored for “LAST MONTH”. Under this condition, if the environmental load information display screen 401 is displayed with the display period set to “LAST MONTH”, there is no job log information that can be referred to. If “LAST MONTH” is selected on the environmental load information display screen 401, the initial values are displayed.

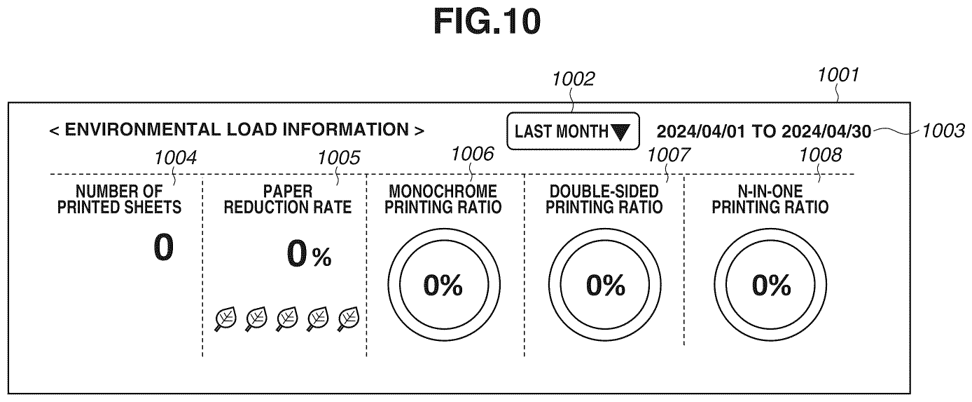

FIG. 10 illustrates an environmental load information display screen 1001, in which “LAST MONTH” has been selected and the initial values are displayed. When there are no jobs stored for “LAST MONTH”, there are no values to be added up. Therefore, all the values of the number of printed sheets 1004, a paper reduction rate 1005, a monochrome printing ratio 1006, a double-sided printing ratio 1007, and an N-in-one printing ratio 1008 are displayed as “0”.

As described above, by notifying the user that the job log information is partially missing before displaying the environmental load information, the user can utilize the numeric values of the environmental load information while being aware of the status of the device and being aware that the job log information within the display period is incomplete.

### Second Embodiment

According to the first embodiment, the user is notified of the status in which the job log information is partially missing via the notification screen displayed before the environmental load information is displayed. According to a second embodiment, the user can be provided with appropriate information by changing the display period 403 in the environmental load information display screen 401.

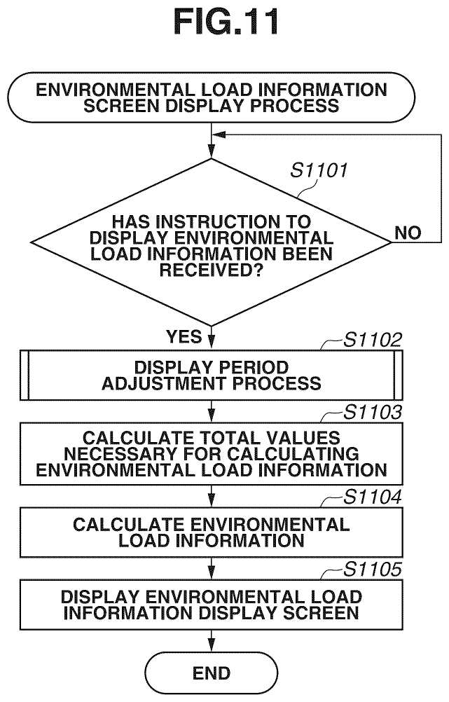

FIG. 11 illustrates a flowchart illustrating display of an environmental load information display screen according to the present embodiment. Since FIG. 11 is similar to FIG. 6, the same steps as those in FIG. 6 will be described with reference to the corresponding steps in FIG. 6.

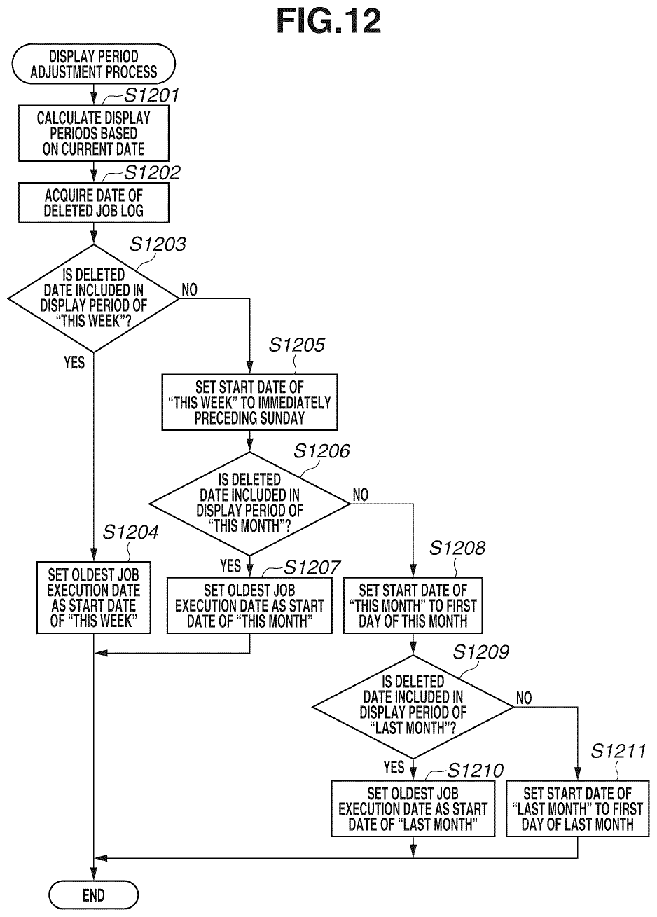

In step S1101, if the CPU 202 receives an instruction to display an environmental load information display screen (YES in step S1101), the process proceeds to step S1102. In step S1102, the CPU 202 performs a display period adjustment process, which will be described in detail below with reference to FIG. 12. By performing this process, a display period corresponding to the storage status of the job log information is calculated. In steps S1103, S1104, and S1105, the CPU 202 performs the same processing as in steps S604, S605, and S609, respectively, and displays the environmental load information display screen including the display period corresponding to the storage status of the job log information. The then process ends.

FIG. 12 is a flowchart illustrating the display period adjustment process in step S1102.

First, in step S1201, as in step S602, the CPU 202 calculates, based on the current date, each of the display periods: “TODAY”; “THIS WEEK”; “THIS MONTH”; and “LAST MONTH”, which are the options of the display period 403, based on the current date.

Next, in step S1202, as in step S701, the CPU 202 acquires the date of the job log information deleted most recently from the storage unit 205. Then, in step S1203, as in step S702, the CPU 202 determines whether the date of the deleted job log information confirmed in step S1202 is included in the display period of “THIS WEEK” calculated in step S1201. If the date of the deleted job log information confirmed in step S1202 is included in the display period of “THIS WEEK” (YES in step S1203), the CPU 202 determines that the job log information in the period included in “THIS WEEK” is partially missing, and the process proceeds to step S1204. If the date of the deleted job log information confirmed in step S1202 is not included in the display period of “THIS WEEK” (NO in step S1203), the CPU 202 determines that there is no missing job log information in the period included in “THIS WEEK”, and the process proceeds to step S1205.

In step S1204, the CPU 202 refers to the job log information 301 and sets the execution date and time of the oldest job executed as the start date of “THIS WEEK”, and the process ends. In step S1205, the CPU 202 sets the start date of “THIS WEEK” to the immediately preceding Sunday, and the process proceeds to step S1206.

In step S1206, the CPU 202 determines whether the date of the deleted job log information is included in the display period of “THIS MONTH” calculated in S1201. If the date of the deleted job log information is included in the display period of “THIS MONTH” (YES in step S1206), the CPU 202 determines that the job log information in the period included in “THIS MONTH” is partially missing, and the process proceeds to step S1207. If the date of the deleted job log information is not included in the display period of “THIS MONTH” (NO in step S1206), the CPU 202 determines that there is no missing job log information in the period included in “THIS MONTH”, and the process proceeds to S1208.

In step S1207, the CPU 202 refers to the job log information 301 and sets the execution date and time of the oldest job executed as the start date of “THIS MONTH”, and the process ends. In step S1208, the CPU 202 sets the start date of “THIS MONTH” to the first day of this month, and the process proceeds to step S1209.

In step S1209, the CPU 202 determines whether the date of the deleted job log information is included in the display period of “LAST MONTH” calculated in step S1201. If the date of the deleted job log information is included in the display period of “LAST MONTH” (YES in step S1209), the CPU 202 determines that the job log information in the period included in “LAST MONTH” is partially missing, and the process proceeds to step S1210. If the date of the deleted job log information is not included in the display period of “LAST MONTH” (NO in step S1209), the CPU 202 determines that there is no missing job log information in the display period that is used as the calculation target for the environmental load information, and the process proceeds to step S1211.

In step S1210, the CPU 202 refers to the job log information 301 and sets the execution date and time of the oldest job executed as the start date of “LAST MONTH”, and the process ends. In step S1211, the CPU 202 sets the start date of “LAST MONTH” to the first day of the last month, and the process ends.

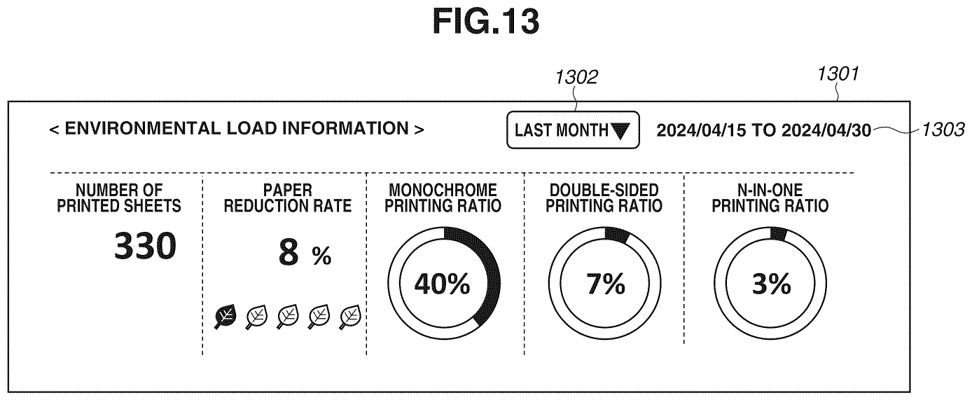

As an example, FIG. 13 illustrates an environmental load information display screen 1301 displayed in step S1105 when “LAST MONTH” has been selected, assuming that the current date is May 23, 2024, and the execution date of the oldest job stored is Apr. 15, 2024. The period of “2024/04/15 to 2024/04/30”, in which the start date is April 15, is displayed as a display period 1303, and the values calculated based on the job log information from April 15 to April 30 are displayed as the numeric values of the environmental load information.

As described above, by changing the date of the display period based on the job log information stored in the device, the user can be notified, without displaying the notification screen, that the environmental load information has been obtained from the middle of the display period.

### Third Embodiment

By selecting the display period of “LAST MONTH”, the user can check the environmental load information for the last month as well as view the current data more objectively. For example, the user can check how much the environmental load has been reduced this month by comparing the environmental load information for “LAST MONTH” with the environmental load information for “THIS MONTH”.

If part of the environmental load information for the last month is missing, the number of days to be compared will be different between this month and the last month, i.e., the condition for the comparison will be different. Even if there is no missing information in the environmental load information for the last month, when the current date is in the beginning of the month, data for only several days can be acquired for this month even though data for approximately 30 days is available for the last month. Therefore, the number of days to be compared will be different in this case as well.

The first and second embodiments have been described based on a case where, when the environmental load information for a selected display period is incomplete, the user is notified of this status. According to a third embodiment, information only about the dates that overlap between “the period from the first day of this month to the current date” and “the period in which the job log information for the last month is stored” is extracted, and a comparison display period is newly set based on the settings. A method for appropriately comparing the environmental load information by using the newly set display period will be described.

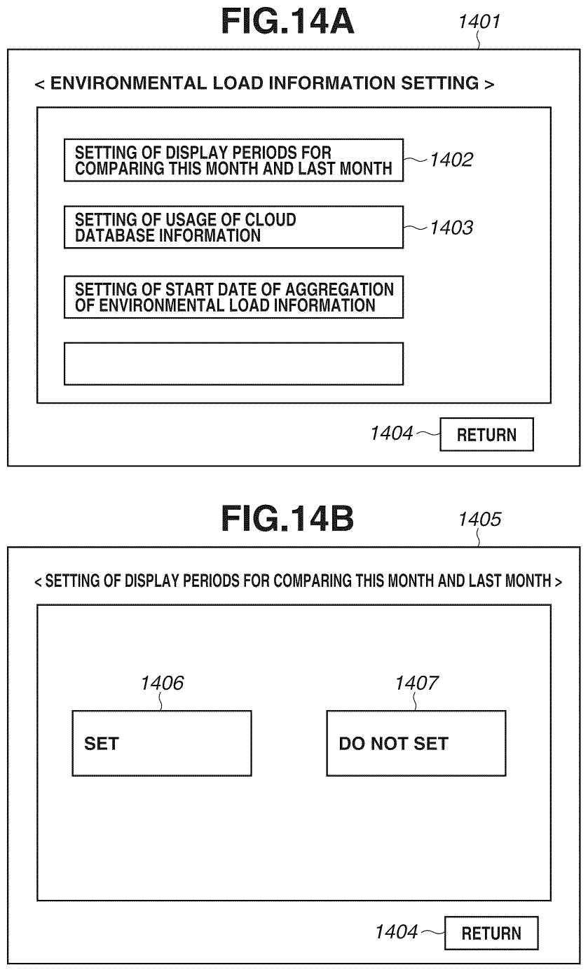

Before a process for displaying the environmental load information for the comparable periods is described, an example of an environmental load information setting item screen will be described with reference to FIG. 14A, and a setting screen for “SETTING OF DISPLAY PERIODS FOR COMPARING THIS MONTH AND LAST MONTH” will be described with reference to FIG. 14B. An environmental load information setting item screen 1401 includes setting menu items such as a “SETTING OF DISPLAY PERIODS FOR COMPARING THIS MONTH AND LAST MONTH” button 1402, a “SETTING OF USAGE OF CLOUD DATABASE INFORMATION” button 1403, and a “RETURN” button 1404. By pressing the “RETURN” button 1404, the screen can transition to a higher-level setting item screen.

When the “SETTING OF DISPLAY PERIODS FOR COMPARING THIS MONTH AND LAST MONTH” button 1402 is pressed, the screen transitions to a setting screen 1405 for “SETTING OF DISPLAY PERIODS FOR COMPARING THIS MONTH AND LAST MONTH”. This screen enables the user to select whether to enable the setting of the display periods for comparing this month and the last month on the environmental load information display screen. The setting screen 1405 for “SETTING OF DISPLAY PERIODS FOR COMPARING THIS MONTH AND LAST MONTH” includes a “SET” button 1406, a “DO NOT SET” button 1407, and a “RETURN” button 1408. By pressing the “SET” button 1406, the display periods of “THIS MONTH (FOR COMPARISON)” and “LAST MONTH (FOR COMPARISON)” become newly available to be selected from the drop-down menu.

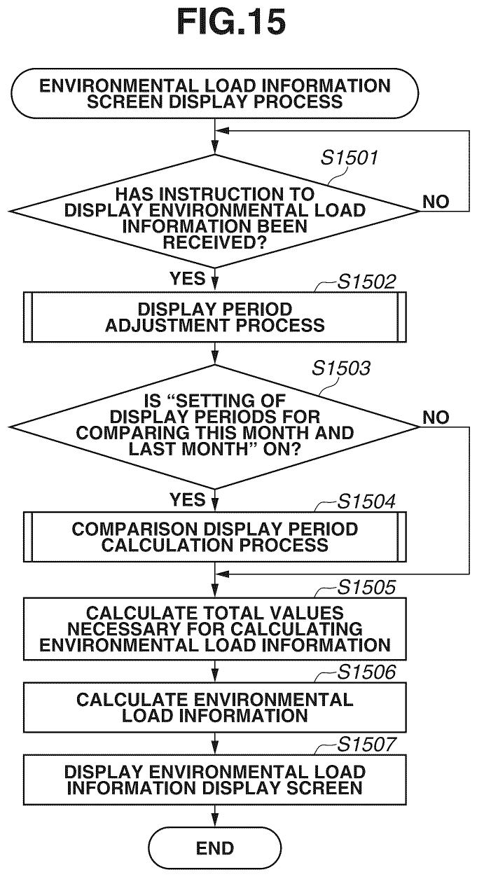

FIG. 15 is a flowchart illustrating a process for displaying the environmental load information for comparable periods. Since the flowchart in FIG. 15 is similar to that in FIG. 11, the same steps as those in FIG. 11 will be described with reference to the corresponding steps in FIG. 11.

In steps S1501 and S1502, the CPU 202 performs the same processing as in steps S1101 and S1102, respectively. In step S1503, the CPU 202 determines whether “SETTING OF DISPLAY PERIODS FOR COMPARING THIS MONTH AND LAST MONTH” is ON. If “SETTING OF DISPLAY PERIODS FOR COMPARING THIS MONTH AND LAST MONTH” is ON (YES in step S1503), the process proceeds to step S1504. If “SETTING OF DISPLAY PERIODS FOR COMPARING THIS MONTH AND LAST MONTH” is not ON (NO in step S1503), the process proceeds to step S1505.

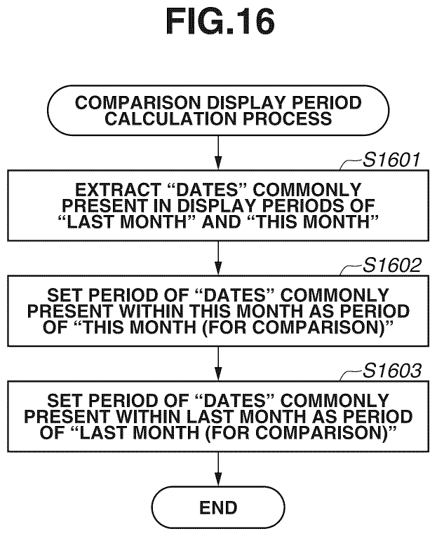

In step S1504, the CPU 202 performs a process for calculating display periods for comparison by focusing on the periods of “THIS MONTH” and “LAST MONTH” calculated in step S1502. The process performed in step S1504 will be described below with reference to FIG. 16. By performing this process, the start date and the end date of each of “THIS MONTH (FOR COMPARISON)” and “LAST MONTH (FOR COMPARISON)” are calculated.

In step S1505, the CPU 202 calculates the total values of the information necessary for the environmental load information based on the job log information within each display period. Specifically, if the process in step S1504 has been performed, the total value for each of the six types of display periods (“TODAY”, “THIS WEEK”, “THIS MONTH”, “LAST MONTH”, “THIS MONTH (FOR COMPARISON)” and “LAST MONTH (FOR COMPARISON)”) is calculated. If the process in step S1504 has not been performed, the total value for each of the four types of display periods (“TODAY”, “THIS WEEK”, “THIS MONTH”, and “LAST MONTH”) is calculated.

In steps S1506 and S1507, the CPU 202 performs the same processing as in steps S1104 and S1105, respectively, and displays the environmental load information display screen, and the process ends.

FIG. 16 is a flowchart illustrating the comparison display period calculation process performed in step S1503.

In step S1601, the CPU 202 refers to the periods of “THIS MONTH” and “LAST MONTH” calculated in step S1502, and extracts “dates” that are commonly present in both periods.

As an example, assuming that the current date is May 23, 2024, and the execution date and time of the oldest job stored is Apr. 5, 2024, the dates common to both the periods of “THIS MONTH” and “LAST MONTH” are “5th to 23rd”.

Next, in step S1602, the CPU 202 sets the start date of “THIS MONTH (FOR COMPARISON)” to the earliest date in the common period, and sets the end date to the latest date in the common period. In this case, the start date is the 5th and the end date is the 23rd.

Next, in step S1603, the CPU 202 sets the start date of “LAST MONTH (FOR COMPARISON)”) to the earliest date in the common period, and sets the end date to the latest date in the common period, and the process ends. In this case, the start date is the 5th and the end date is the 23rd.

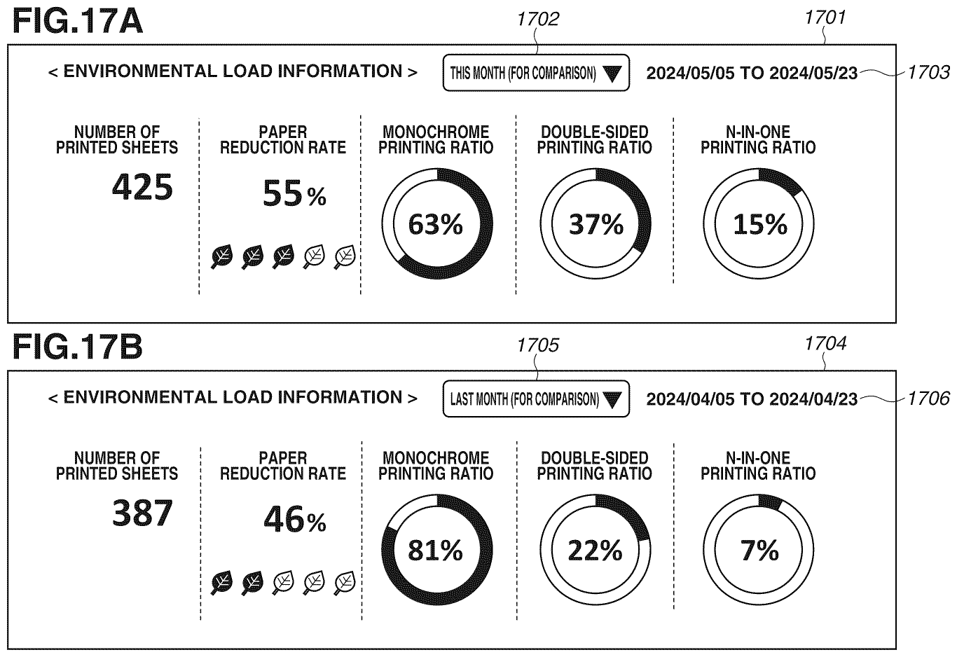

FIGS. 17A and 17B illustrate, as an example, the environmental load information display screens displayed in step S1507 when the current date is May 23 2024, and the execution date and time of the oldest job stored is Apr. 5, 2024. FIG. 17A illustrates a screen example when “THIS MONTH (FOR COMPARISON)” has been selected, and FIG. 17B illustrates a screen example when “LAST MONTH (FOR COMPARISON)” has been selected. Display periods 1703 and 1706 both have the dates of 5th to 23rd. When FIGS. 17A and 17B are compared with each other, the numeric values of the paper reduction rate, the double-sided printing ratio, etc. of this month are better than those of the last month in the same period of days, that is, more environmental load has been reduced this month.

As describe above, by setting the display periods for comparison, this month and the last month can be compared with each other over the same time frame and number of days. Thus, the numeric values can be compared more easily. As a result, plans for reducing the environmental load in the future can be made more easily.

### Fourth Embodiment

In the first to third embodiments, the issues and solutions in referring to the job log information stored in the device have been described. However, the environmental load information can be calculated by referring to the job log information stored external to the device, for example, by referring to the job log information stored in a cloud environment or a data server. A fourth embodiment will be described based on a case where the job log information stored external to the device is used.

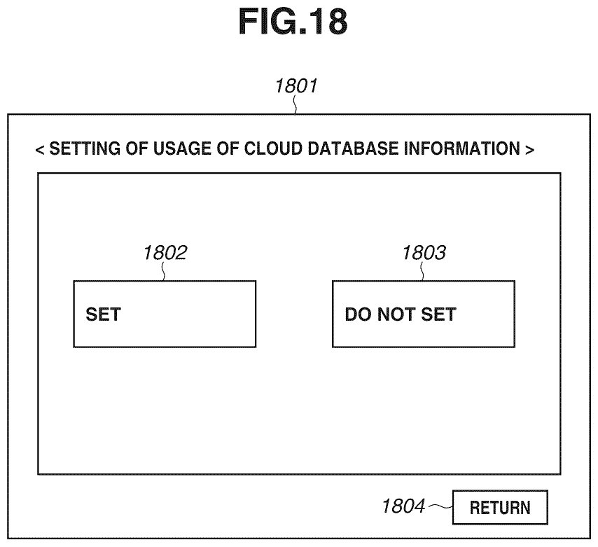

Before describing the process of the fourth embodiment, a setting screen for using information stored in the cloud database 210 will be described with reference to FIG. 18. A setting screen 1801 for “SETTING OF USAGE OF CLOUD DATABASE INFORMATION” is a screen that is transitioned to when the user presses the “SETTING OF USAGE OF CLOUD DATABASE INFORMATION” button 1403 of the environmental load information setting item screen 1401. The setting screen 1801 includes a “SET” button 1802, a “DO NOT SET” button 1803, and a “RETURN” button 1804. When part of the job log information stored in the storage unit 205 has been deleted in any of the display periods, a process for acquiring the job log information stored in the cloud database 210 is performed when the user presses the “SET” button 1802.

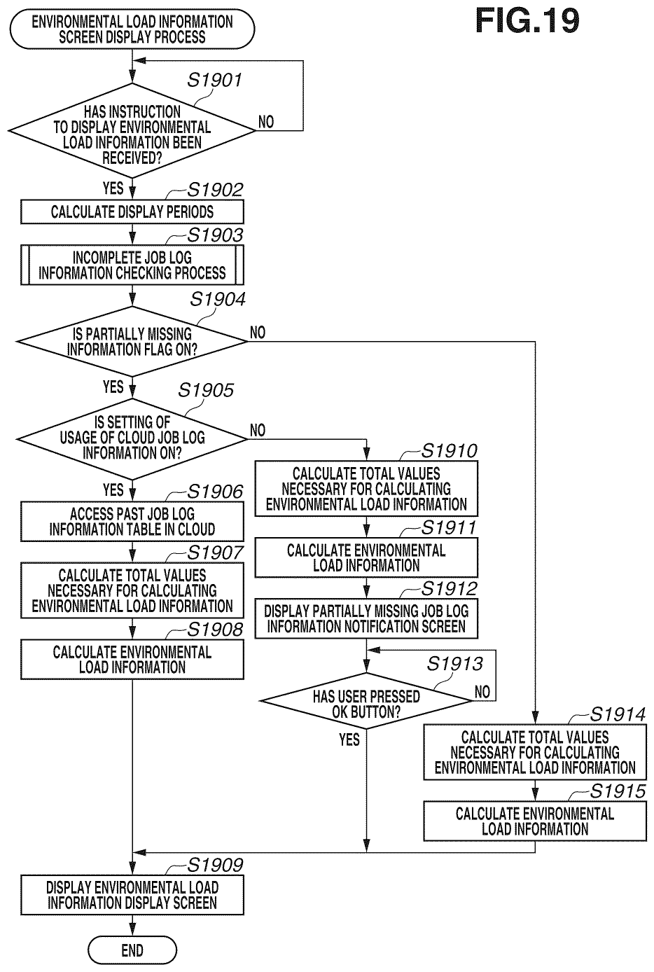

FIG. 19 is a flowchart illustrating a process for calculating the environmental load information by referring to the information stored external to the device based on the setting status in FIG. 18. Since FIG. 19 is similar to FIG. 6, the same steps as those in FIG. 6 will be described with reference to the corresponding steps in FIG. 6.

In steps S1901 to S1903, the CPU 202 performs the same processing as in steps S601 to S603, respectively, and checks whether part of the job log information stored in a device is missing (whether there is any difference). Next, in step S1904, the CPU 202 determines whether the partially missing information flag has been set to ON in the processing in step S1903. If the partially missing information flag is ON (YES in step S1904), the process proceeds to step S1905. If the partially missing information flag is not ON (NO in step S1904), the process proceeds to step S1914.

In step S1905, the CPU 202 checks whether the “SETTING OF USAGE OF CLOUD DATABASE INFORMATION” is ON. If the “SETTING OF USAGE OF CLOUD DATABASE INFORMATION” is ON (YES in step S1905), the process proceeds to step S1906. If the “SETTING OF USAGE OF CLOUD DATABASE INFORMATION” is not ON (NO in step S1905), the process proceeds to step S1910.

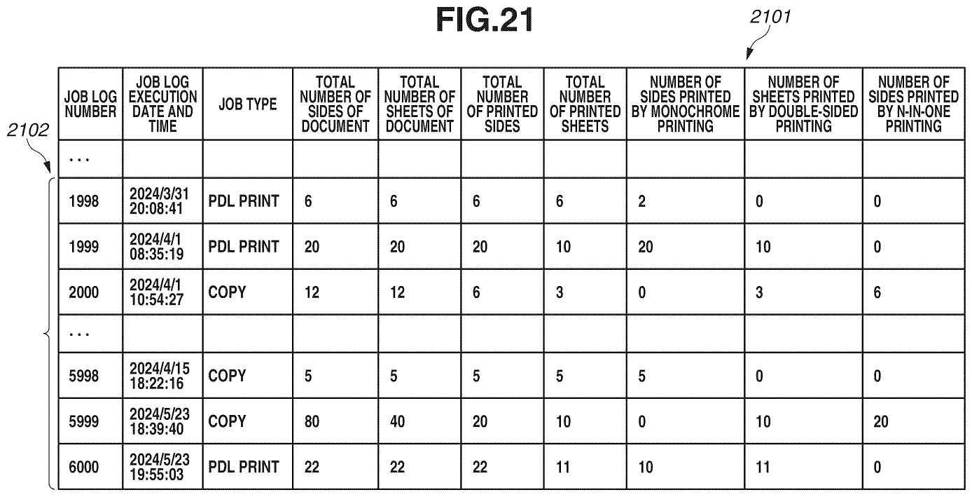

In step S1906, the CPU 202 accesses the cloud database 210 via the network 201 and refers to a past job log information table. FIG. 21 illustrates an example of the past job log information table. A past job log information table 2101 has the same format as the job log information table 301 on the device, and the job log entries exceeding the upper storage limit on the device are sequentially stored in the past job log information table 2101.

Returning to FIG. 19, in step S1907, the CPU 202 calculates, based on the job log information stored in each of the cloud database 210 and the storage unit 205, the total values necessary for calculating the environmental load information. Next, in step S1908, the CPU 202 calculates the environmental load information, and the process proceeds to S1909. In step S1909, the CPU 202 displays the environmental load information display screen on the UI screen 109, and then the process ends. In the case of an example of the present embodiment, the CPU 202 refers to the entire job log information table 301 illustrated in FIG. 3 and a group of job log entries 2102 from Apr. 1, 2024, to Apr. 15, 2024, included in the past job log information table 2101 illustrated in FIG. 21. In this way, the total values necessary for calculating the environmental load information are calculated.

In step S1910, following step S1905, while the job log information is partially missing, the setting for using the job log information in the cloud database 210 is not ON. Thus, as in the first embodiment, the CPU 202 performs the processing for displaying the partially missing job log information notification screen 801. Therefore, in steps S1910, S1911, S1912, and S1913, the CPU 202 performs the same processing as in steps S604, S605, S607, and S608, respectively, and displays the partially missing job log information notification screen 801. Next, in step S1909, the CPU 202 displays the environmental load information display screen on the UI screen 109, and then the process ends.

In step S1914, following step 1904, since the job log information within each display period is complete, the CPU 202 displays the environmental load information display screen, without accessing the cloud or displaying the notification screen. Thus, in step S1914, the CPU 202 calculates the total values necessary for the environmental load information, and in step S1915, the CPU 202 calculates the environmental load information. Next, in step S1909, the CPU 202 displays the environmental load information display screen on the UI screen 109, and then the process ends.

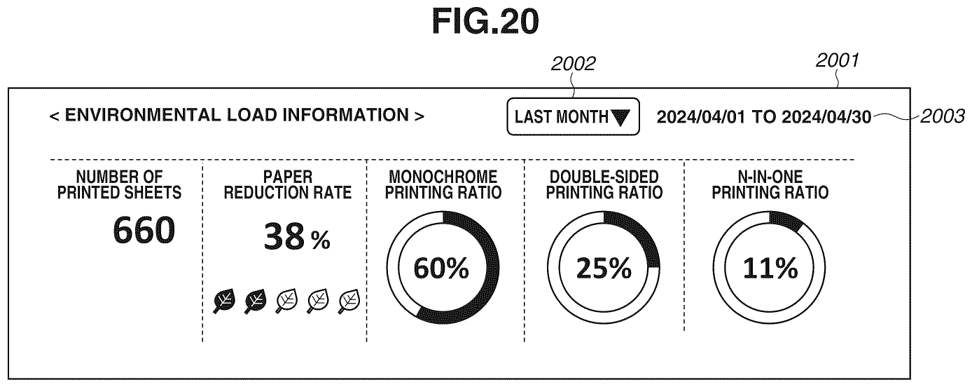

An example will be described where the current date is May 23, 2024 and the execution date and time of the oldest job stored in the storage unit 205 is Apr. 15, 2024. FIG. 20 illustrates an environmental load information display screen 2001 to be displayed, per this example, if the CPU 202 determines that the “SETTING OF USAGE OF CLOUD DATABASE INFORMATION” is ON in step S1905. FIG. 21 illustrates an example of the past job log information table 2101 stored in the cloud database 210. Compared with the environmental load information display screen 901 in FIG. 9 displayed if the CPU 202 determines that the “SETTING OF USAGE OF CLOUD DATABASE INFORMATION” is OFF, the environmental load information display screen 2001 indicates that a greater number of printed sheets is used, that is, job log information for a longer period is used.

The CPU 202 accesses the cloud database 210, and acquires the group of job log entries 2102 for the period from Apr. 1, 2024, to Apr. 14, 2024, which is the missing job log information. In this way, the job log information for April 2024, which corresponds to “LAST MONTH”, can be entirely used for the environmental load information without any deficiency.

As described above, even when the job log information stored on a device is partially missing, by referring to the past job log information stored in the cloud environment based on the user setting, it is possible to calculate the environmental load information based on the sufficient job log information for each display period, thus being able to present the obtained environmental load information to the user.

### Fifth Embodiment

The first to fourth embodiments have been described based on the case in which the environmental load information is calculated by directly referring to a job log information table. However, the present disclosure is not limited to this case. Only the job types and values for the dates necessary for calculating the environmental load information may be extracted from the job log information table, and the extracted information may be compiled into another table. The environmental load information may be calculated by referring to this table.

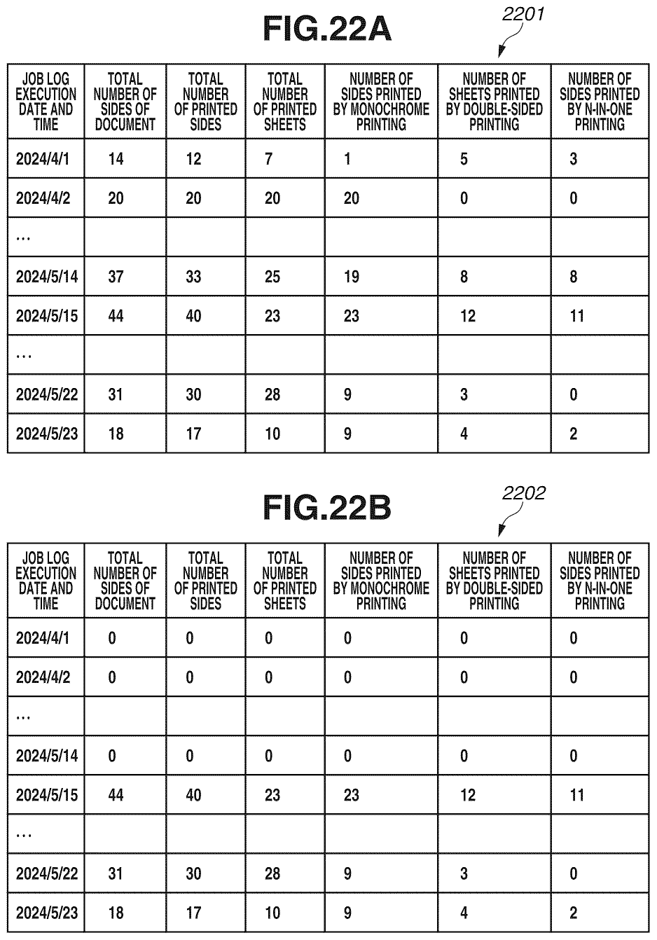

As examples, FIGS. 22A and 22B illustrate tables, in each of which values necessary for calculating the environmental load information are compiled per job execution date. By using an environmental load information table 2201 as illustrated in FIG. 22A, the job log information can be separately managed without being directly affected by the upper storage limit to the number of job log entries. When the environmental load information table is initially created, if part of the job log information corresponding to the jobs executed from the “first day of the last month to the current date”, which is the aggregation range of the table, has already been deleted, an environmental load information table 2202 as illustrated in FIG. 22B is created.

In this case, the same issues as those in the cases described in the previous embodiments may occur, and therefore, each solution of the present disclosure is effective.

### Other Embodiments

Although various examples and embodiments of the present disclosure have been described above, the spirit and scope of the present disclosure are not limited to the specific descriptions in this specification.

The present disclosure can also be implemented by supplying a program that realizes one or more functions of the above-described embodiments to a system or apparatus via a network or a storage medium, and causing one or more processors of a computer in the system or apparatus to read and execute the program. The present disclosure can also be implemented by a circuit (for example, an Application Specific Integrated Circuit (ASIC)) that realizes one or more functions.

According to the present disclosure, the user can be provided with the storage status of job log information, which the user is not aware of and which is stored inside a device. Thus, the user can be aware of environmental load information more accurately.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc(BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-191752, filed Oct. 31, 2024, which is hereby incorporated by reference herein in its entirety.

What is claimed is:

1. An image forming apparatus, comprising:
a storage unit configured to store execution date and time of a print job and setting information of the executed print job in association with each other;
at least one memory storing a program;
at least one processor, that when executing the program, is caused to:
set a period having a predetermined unit;
acquire, from the storage unit, the setting information of print jobs executed within the set period; and
calculate information about environmental load based on the setting information; and
a display unit configured to display the information about the environmental load,
wherein the display unit displays a warning about the displayed information about the environmental load in a case where the period is set and a condition is satisfied for the period.

2. The image forming apparatus according to claim 1, wherein, in the case where the period is set and the condition is satisfied for the period, the display unit displays a period in which the setting information, which serves as a source of the information about the environmental load, is acquired within the set period.

3. The image forming apparatus according to claim 1, wherein the condition is that the setting information of the print jobs, which are executed within the period and stored in the storage unit, is not the setting information of all the print jobs executed within the period.

4. The image forming apparatus according to claim 1, wherein the period having the predetermined unit is at least a first period of only a current date on which the image forming apparatus is operated, a second period from Sunday to the current date, or a third period from a beginning of a month related to the current date to the current date.

5. The image forming apparatus according to claim 1, further comprising an interface configured to communicate with an external device,
wherein the interface acquires, from the external device, the setting information of a print job corresponding to a difference between all print jobs executed within the period and print jobs executed within the period and stored in the storage unit, and
wherein the display unit displays information about environmental load based on the setting information about all the print jobs executed within the period.

6. The image forming apparatus according to claim 1, wherein the setting information includes at least one item of information of a double-sided printing setting, information of a monochrome printing setting, or information of an N-in-one printing setting.

7. The image forming apparatus according to claim 1, wherein the information about the environmental load includes at least one of a ratio of sheets printed by double-sided printing, a ratio of sheets printed by monochrome printing, or a ratio of sheets printed by N-in-one printing.

8. The image forming apparatus according to claim 1, wherein the warning includes date information specifically indicating the period.

9. A method for an image forming apparatus including a display unit configured to display information and a storage unit configured to store execution date and time of a print job and setting information of the executed print job in association with each other, the method comprising:
setting a period having a predetermined unit;
acquiring, from the storage unit, the setting information of print jobs executed within the set period;
calculating information about environmental load based on the setting information; and
displaying the information about the environmental load,
wherein the displaying includes displaying a warning about the displayed information about the environmental load in a case where the period is set and a condition is satisfied for the period.

10. A computer-readable storage medium storing a program for causing an image forming apparatus, including a display unit configured to display information and a storage unit configured to store execution date and time of a print job and setting information about the executed print job in association with each other, to execute a method, the method comprising:
setting a period having a predetermined unit;
acquire, from the storage unit, the setting information of print jobs executed within the set period;
calculate information about environmental load based on the setting information; and
display the information about the environmental load,
wherein the displaying includes displaying a warning about the displayed information about the environmental load in a case where the period is set and a condition is satisfied for the period.
